(19) United States
(12) Patent Application Publication
(10) Pub. No.: US 2014/0037441 A1
(43) Pub. Date: Feb. 6, 2014

(54) RAM AIR FAN DIFFUSER

(71) Applicants: Eric Chrabascz, Longmeadow, MA (US); Victoria S. Richardson, Hartford, CT (US); David A. Dorman, Feeding Hills, MA (US)

(72) Inventors: Eric Chrabascz, Longmeadow, MA (US); Victoria S. Richardson, Hartford, CT (US); David A. Dorman, Feeding Hills, MA (US)

(21) Appl. No.: 13/567,295

(22) Filed: Aug. 6, 2012

(51) Int. Cl. F04D 29/54; B23P 15/02

(52) U.S. Cl. 415/207; 29/888.025

(57) ABSTRACT

A disclosed ram air assembly includes a housing that defines an inlet and an inner cavity. A fan disposed at the inlet generates air flow and is driven by an electric motor. Airflow through the ram air fan assembly is directed through a passageway defined by a diffuser. The diffuser includes a first diameter at a forward end, and a second diameter at an aft end with the second diameter being larger than the forward end to diffuse airflow and increase fan efficiency.

### BACKGROUND

Ram airflow is utilized in many aircraft applications such as cooling system and environmental control systems of the aircraft. During aircraft operation, movement of air is provided by the movement of the aircraft. However, when an aircraft is on the ground, such airflow is not provided and although still required, cannot be provided by movement of the aircraft. Accordingly, a ram air fan system is provided to draw air from around the aircraft through passages that communicate with the various systems that require cooling air. Typically, this cooling air is drawn by a fan driven by an electric motor. The flow of cooling air, and thus the performance of the fan and the electric motor are limited by the efficiency of airflow through the ram air fan system. Moreover, the flow of air through the ram air fan system can generate undesirable levels of noise during operation.

Accordingly, it is desirable to develop a ram air fan system that efficiently produce airflow while limiting noise to within desirable levels during operation.

### SUMMARY

An example disclosed ram air assembly includes a housing that defines an inlet and an inner cavity. A fan disposed at the inlet generates air flow and is driven by an electric motor. Airflow through the ram air fan assembly is directed through a passageway defined by a diffuser. The diffuser includes a first diameter at a forward end, and a second diameter at an aft end with the second diameter being larger than the first diameter to diffuse airflow and increase fan efficiency.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a cross-sectional view of an example ram air fan assembly.

FIG. 2 is a cross-sectional view of an example diffuser.

FIG. 3 is a side view of an example perforated sheet.

FIG. 4 is an enlarged view of example openings in the example perforated sheet material.

### DETAILED DESCRIPTION

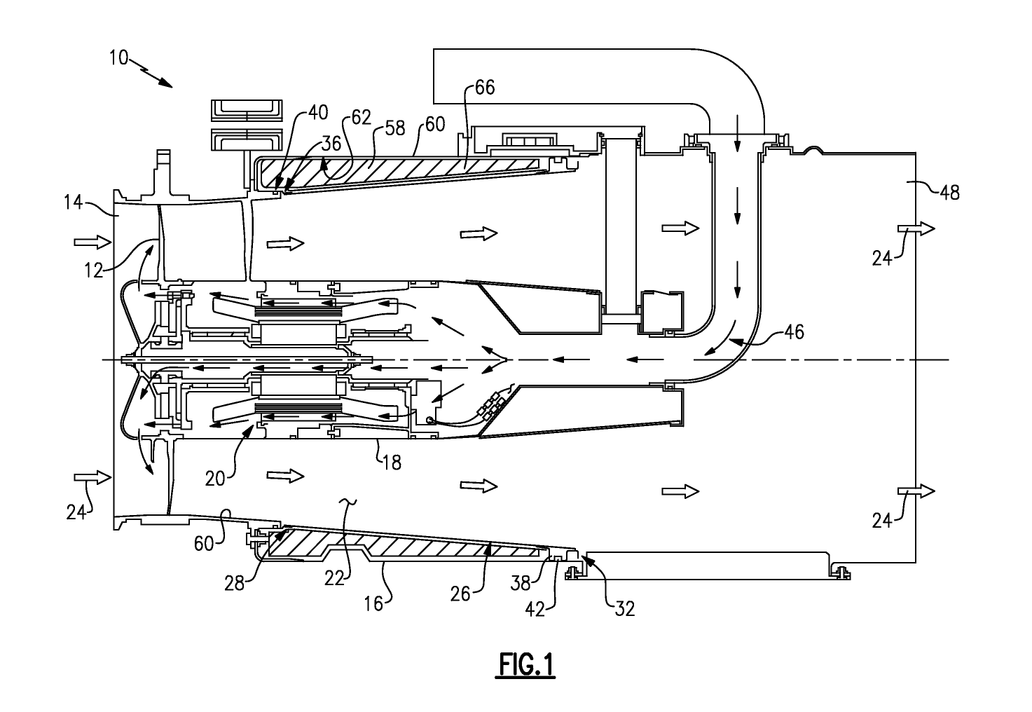

FIG. 1 schematically illustrates a disclosed example ram air fan assembly 10. The ram air assembly 10 includes a fan 12 disposed at an inlet 14 of an outer housing 16. The outer housing 16 includes the inlet 14 and an outlet 48. The outlet 48 provides airflow schematically indicated by arrows 24 to a heat exchanger (not shown) or other features of an aircraft that require cooling airflow when at low speeds or on the ground. An electric motor 20 is disposed within an inner housing 18. The inner housing 18 is supported within the outer housing 16. The motor 20 receives airflow 46 through a separate conduit for cooling the motor 20. Airflow drawn through the inlet 14 is directed through a passageway 22 defined by a diffuser 26. The example diffuser 26 is supported within a cavity 60 defined by the outer housing 16.

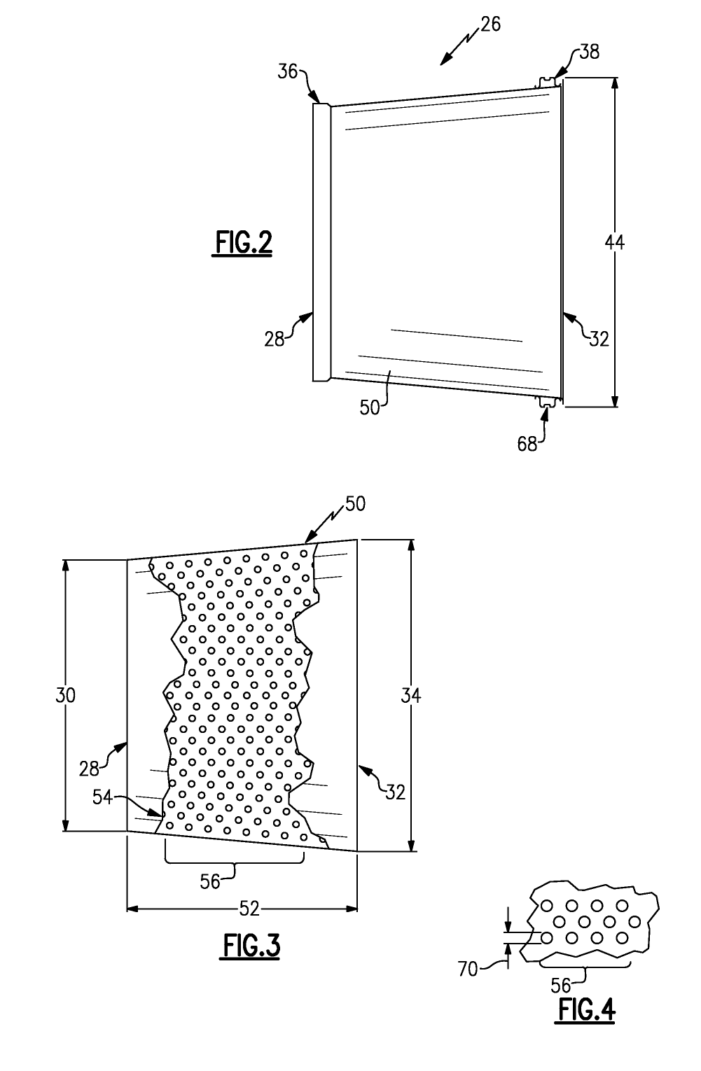

Referring to FIGS. 2 and 3 with continued reference to FIG. 1, the diffuser 26 defines a part of the airflow passage 22 and includes a forward end 28 and an aft end 32. The diffuser 26 is formed of a perforated metal sheet 50 that extends annularly from the forward end 28 to the aft end 32. The forward end 28 includes a first diameter 30 and the aft end 32 includes a second diameter 34 (FIG. 3). The second diameter 34 is larger than the first diameter 30 to provide an increasing flow area in a direction towards the outlet 48 and away from the fan 12. The increased flow area in a direction away from the fan 12 provides the desired diffusion rate that improves operating efficiency of the fan 12.

In a disclosed non-limiting dimensional embodiment, the first diameter 30 is between about 13.735 and 13.765 inches (34.9-35.0 cm) and the second diameter 34 is between about 15.800 and 15.830 inches (40.1-40.2 cm). In one disclosed example, a ratio between the first diameter 30 and the second diameter 34 is between approximately 0.85 and 0.089. In another example embodiment, the ratio between the first diameter 30 and the second diameter 34 is between about 0.86 and 0.88.

The forward end 28 is spaced an axial distance 52 from the aft end 32. The axial distance 52 combined with the difference between the first diameter 30 and the second diameter 34 provides the desired angle and increase in airflow area of the airflow passage 22. The disclosed example diffuser 26 includes a ratio of the second diameter 34 to the axial distance 52 that is between 1.30 and 1.36. In another disclosed example, the ratio of the second diameter 34 to the axial distance 52 is between 1.33 and 1.35. In one disclosed non-limiting dimensional example the axial distance is about 11.73 inches (29.8 cm). The ratio between the second diameter 34 and the axial distance 52 defines the increasing airflow area that provides a desired airflow efficiency of the fan 12.

A forward rim 36 is attached to an outer surface of the diffuser 26 at the forward end 28. An aft rim 38 is attached to the outer surface of the diffuser 26 at the aft end 32. The example forward rim 36 and the aft rim 38 are fabricated from a carbon matrix material and formed in a desired shape to interface with the inner surface 62 of the outer housing 16. In this example, the aft rim 38 defines a third diameter 44 (FIG. 3) that corresponds with an inner surface 62 of the outer housing 16 to provide a desired fit and seal therebetween.

The aft rim 38 includes a channel 68 that receives an aft seal 42 (FIG. 1). The aft seal 42 is disposed within the channel 68 between the inner surface 62 of the outer housing 16 and the aft rim 38. The dimensions of the aft rim 38 correspond with the inner surface 62 of the outer housing 16 such that a desired force and fit for the seal 42 on the inner surface 62 of the outer housing 16 is provided. In one disclosed example, a ratio of the third diameter 44 and the first diameter 30 is between about 1.15 and 1.25. In another disclosed example, the ratio of the third diameter 44 to the first diameter is between about 1.19 and 1.21. The ratio between the third diameter 44 and the first diameter 30 describes the desired sealing fit between the diffuser 26 and the outer housing 16. Moreover, the diameter 44 corresponds with the desired increasing flow area of the air passage 22 defined by the diffuser 26. In one non-limiting dimensional example, the third diameter is between 16.54 and 16.58 inches (42.0-42.1 cm).

Referring to FIGS. 3 and 4 and with continued reference to FIG. 2, the example diffuser 26 is fabricated utilizing the perforated metal sheet 50. The perforated metal sheet includes a plurality of openings 56 to define a desired open area 54. In this disclosed example, the desired open area is greater than about 55%. In another disclosed example embodiment, the open area 54 is approximately 65%.

Each of the plurality of openings 56 includes a diameter 54. In this example the diameter 70 is approximately 0.100 inches (0.3 cm). As appreciated, the specific open area and size of each of the plurality of openings 56 may differ to provide the desired communication through the perforated metal sheet 50.

Referring to FIG. 1, with continued reference to FIGS. 3 and 4, the openings 56 through perforated metal sheet 50 communicate sound energy through the diffuser 26 into an annular cavity 66 defined between an outer surface of the diffuser 26 and the inner surface 62 of the outer housing 16. The cavity 66 contains an acoustic material 58 that deadens vibratory energy that generates noise produced by high velocity airflow through the diffuser 26 and passageway 22.

The example cavity 66 also includes an inner wrap 64 that is wrapped around an outer surface of the diffuser 26. This inner wrap 64 is comprised of a material that prevents the acoustic material 58 from being pulled through the plurality of openings 56 in response to the high velocity airflow through the passageway 22.

Accordingly, the example diffuser assembly 26 includes features providing improved fan operation while reducing generated noise.

Although an example embodiment has been disclosed, a worker of ordinary skill in this art would recognize that certain modifications would come within the scope of this disclosure. For that reason, the following claims should be studied to determine the scope and content of this disclosure.

What is claimed is:

1. A ram air fan assembly comprising:
a housing defining an inlet and an inner chamber;
a fan disposed at the fan inlet;
a motor connected to drive the fan; and
a diffuser mounted within the housing and defining an airflow passage, the diffuser including a first diameter at a forward end and a second diameter at an aft end spaced axially apart from the forward end, wherein a ratio of the first diameter to the second diameter is between 0.85 and 0.89.

2. The ram air fan assembly as recited in claim 1, wherein the ratio of the first diameter to the second diameter is between about 0.86 and 0.88.

3. The ram air fan assembly as recited in claim 1, including an aft rim attached to the aft end and a forward rim attached to the forward end, the aft rim and the forward rim engaging an inner surface of the housing for securing the diffuser in place within the housing.

4. The ram air fan assembly as recited in claim 3, including an aft seal supported on the aft rim.

5. The ram air fan assembly as recited in claim 3, wherein the aft rim defines a third diameter and a ratio of the third diameter to the first diameter is between 1.15 and 1.25.

6. The ram air fan assembly as recited in claim 3, wherein the aft rim defines a third diameter and a ratio of the third diameter to the first diameter is between 1.19 and 1.21.

7. The ram air fan assembly as recited in claim 1, wherein the forward end is spaced from the aft end an axial distance and a ratio of the second diameter to the axial distance is between 1.30 and 1.36.

8. The ram air fan assembly as recited in claim 1, including noise attenuation material disposed within a space between the diffuser and the inner surface of the housing.

9. A diffuser for a ram air fan comprising:
a perforated sheet disposed about an axis and defining an airflow passage, the perforated sheet including a forward end having a first diameter and an aft end having a second diameter greater than the first diameter, wherein a ratio of the first diameter to the second diameter is between about 0.85 and 0.89;
a forward rim attached to the perforated sheet at the forward end; and
an aft rim attached to the perforated sheet at the aft end.

10. The diffuser as recited in claim 9, wherein the forward end is spaced apart from the aft end an axial distance and the a ratio of the second diameter to the axial distance is between 1.30 and 1.36.

11. The diffuser as recited in claim 9, wherein the aft rim defines a third diameter and a ratio of the third diameter to the first diameter is between 1.15 and 1.25.

12. The diffuser as recited in claim 9, wherein the perforated sheet includes a plurality of openings and defining an open area greater than 55%.

13. The diffuser as recited in claim 12, wherein each of the plurality of openings define an opening size greater than about 0.100 inches (0.3 cm).

14. The diffuser as recited in claim 9, including an aft seal supported on the aft rim.

15. A method of assembling a ram air fan comprising:
mounting a fan at an inlet of an outer housing for rotation about an axis; and
mounting a diffuser within the outer housing to define an air passage for airflow from the fan through the inlet, wherein the air passage includes a forward end having a first diameter and an aft end having a second diameter with a ratio of the first diameter to the second diameter between 0.85 and 0.89.

16. The method as recited in claim 15, including attaching a forward rim to the forward end of the diffuser and an aft rim to the aft end of the diffuser with the aft rim defining a third diameter with a ration between the third diameter and the first diameter being between 1.15 and 1.25.

17. The method as recited in claim 15, including spacing the forward end an axial distance from the aft end, with a ratio of the axial distance to the second diameter being between 1.30 and 1.36.

18. The method as recited in claim 15, including installing an aft seal between the aft rim and an inner surface of the outer housing.
